(19) United States
(12) Patent Application Publication
(10) Pub. No.: US 2011/0056454 A1
(43) Pub. Date: Mar. 10, 2011

(54) STRUCTURE OF CRANKCASE

(75) Inventor: Taro Tsukamoto, Kanagawa (JP)

(73) Assignee: Mitsubishi Heavy Industries, Ltd., Tokyo (JP)

(21) Appl. No.: 12/989,502

(22) PCT Filed: Sep. 17, 2009
(86) PCT No.: PCT/JP2009/066266

§ 371 Date: Nov. 16, 2010

(30) Foreign Application Priority Data
Dec. 11, 2008 (JP) 2008-315394

(51) Int. Cl. F02F 7/00

(52) U.S. Cl. 123/195 R

(57) ABSTRACT

An object of the present invention is to propose a structure of a crankcase capable of coping with increased combustion pressure inside a cylinder of an engine by a simple and inexpensive means for suppressing the deformation at a middle section between adjacent fastening bolts in a direction connecting the centers of adjacent cylinders. The structure of the crankcase which has a plurality of cylinders and a plurality of bolts arranged on both sides of each of the cylinders for fastening the cylinders to a cylinder head, the structure of the crankcase comprises a reinforcing rib 6 formed on an outer wall of the cylinder at a middle section between the adjacent fastening bolts 3 in a direction 20 connecting centers of the adjacent cylinders, the reinforcing rib extending downward continuously from the cylinder top plate in a direction parallel to a center line 4a of the cylinder.

### BACKGROUND OF THE INVENTION

1. Field of the Invention

The present invention relates to a structure of a crankcase which is applicable to a diesel engine and has a plurality of cylinders having plural bolts on both sides of each cylinder for fixing to a cylinder head.

2. Description of the Related Art

Many means have been tried to improve the strength of crankcase components of a diesel engine of recent years with higher supercharging and higher output.

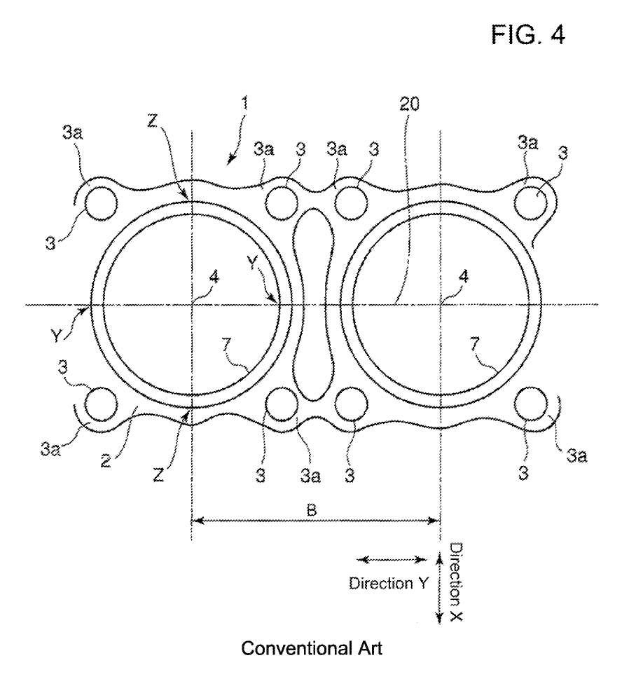

FIG. 4 is a plain view of main parts of a cylinder block from above as an example of a conventional crankcase for a diesel engine having two cylinders.

In FIG. 4, a crankcase 1 comprises two cylinders in line installed upright adjacent to each other. Further, a plurality of bolts for fastening each of the cylinders 7 to the cylinder head are provided on a cylinder wall arranged around each of the cylinders. Throughout the drawings, the fastening bolts are shown as fastening bolt holes 3. In FIG. 4, head bolt reinforcing members 3a are provided around the cylinder hole and each of the reinforcing members protrudes around the cylinder hole by 45 degree from each other from the horizontal and vertical lines and the fastening bolt holes are bored to meet the reinforcing members.

The crankcase 1 has a cylinder top panel 2 formed on the top thereof and reinforcing members such as head bolt reinforcing members 3a installed consecutively around the bolt holes 3.

The reinforcing members such as the head bolt reinforcing members 3a supports the force acting on the crankcase by supporting the crankcase 1.

In the crankcase 1 of the engine, the deformation of the cylinder top plate becomes more evident in response to the higher supercharging and higher output of the engine. Particularly, the deformations often take place in a middle section of the fastening bolts 3, in a section between the fastening bolts in the horizontal line 20 connecting the centers of two adjacent cylinders, in particular, sections Z on the vertical lines from the centers of the cylinders and sections Y on the horizontal lines 20 perpendicular to the vertical lines.

To take measures against the deformations of the crankcase 1 and the cylinder head, Patent Document 1 (JP10-311242A) proposes a two-part structure of a cylinder block to prevent the deformation of the crankcase in order to prevent the deformation of the crankcase and Patent Document 2 (JP2000-310157A) proposes to improve reliability while coping with the high output of a diesel engine of in-line four cylinder type, by increasing the cooling performance in the vicinity of a cylinder axis center having a high load, and the rigidity of a cylinder head around a cylinder in particular, in the cylinder head by providing reinforcing ribs over an upper surface of the lower deck part of the cylinder head and also cross drill holes for leading cooling water into the reinforcing ribs. However, the object of Patent Document 1 is to solve the problems in the case of using the cylinder block of the two-part structure and Patent Document 2 relates to the cylinder head instead of the crankcase.

Even with the methods disclosed in the documents, it still requires to increase the force to fasten the cylinder head bolts and also to modify the cylinder top plate 2 of the engine to a large extent in order to cope with the increase in the combustion pressure inside the cylinder in response to the higher supercharging and higher output of the engine.

The deformations of the cylinder top plate 2 are more evident in places far from the cylinder head fastening bolts 3, e.g. at the sections Z on the vertical lines from the centers of the cylinders and sections Y on the horizontal lines 20 perpendicular to the vertical lines.

The deformation of the cylinder top plate 2 causes a droop of the top plate 2 toward inside of the hole of the cylinder 7. At the sections Y which intersect the horizontal lines 20 connecting the centers of the adjacent cylinders, the deformation is small due to the number of bosses arranged around it and the reinforcing is easy.

However, at the middle sections Z between the fastening bolts 3 on the horizontal line 20 (the middle sections Z are located on the vertical line of the cylinder center), the number of the bosses is small and thus the deformation is more evident and it is difficult to reinforce the area.

### RELATED PATENT DOCUMENT

### [PATENT DOCUMENT 1] JP10-311242A

### [PATENT DOCUMENT 2] JP2000-310157A

### SUMMARY OF THE INVENTION

In view of the above issues, an object of the present invention is to provide a structure of a crankcase which is capable of coping with increased combustion pressure inside a cylinder of an engine having a plurality of cylinders (in-line cylinders) with a means for suppressing the deformation near a middle section (section Z) between fastening bolts in a direction parallel to a center-connecting line (horizontal line) connecting centers of the pair of the adjacent cylinders.

To achieve the object of the present invention, the present invention proposes structure of a crankcase, which has a plurality of in-line cylinders installed upright in vicinity of each other, and a plurality of bolts arranged on an outer wall surrounding each of the cylinders for fastening the cylinders to a cylinder head, the structure comprising: a reinforcing rib formed on the outer wall at a middle section between the adjacent fastening bolts in a direction parallel to a direction of a center-connecting line connecting centers of the adjacent cylinders, the reinforcing rib extending downward continuously from the cylinder in the direction parallel to the center line of the cylinder.

The reinforcing rib may have the structures shown below.
(1) The reinforcing rib is provided at each of the middle sections between the adjacent fastening bolts in a direction connecting centers of the adjacent cylinders.
(2) The reinforcing rib is provided at each of the middle sections and the reinforcing rib has a semicircular cross-sectional shape in the same manner as bosses for the fastening bolts.
(3) The reinforcing rib connects to a vertical part of the crankcase at a connection section thereof which is arranged lower than a supporting boss of the crankcase for supporting a cylinder liner.

According to the present invention, in the structure of the crankcase, the deformation of the cylinder top plate is substantially high at the middle section between fastening bolts in a direction parallel to a center-connecting line (horizontal line) connecting centers of the pair of the adjacent cylinders as there are only few bosses around the middle section. In the present invention, the reinforcing rib is formed on the outer wall of the cylinder at the middle section in the direction connecting centers of the adjacent cylinders and the reinforcing rib extends downward continuously from the bottom surface of the cylinder top plate in a direction parallel to the center line of the cylinder so as to improve the rigidity at the middle section and further prevents the droop of the top plate toward inside of the cylinder, thereby preventing the deformation of the cylinder top plate.

Therefore, the crankcase of the engine, which is capable of coping with increased combustion pressure inside the cylinder due to a high supercharging and a high output of an engine can be obtained by simply adding the reinforcing rib of a simple and inexpensive structure requiring only few extra processes, which can suppress the deformation at the middle section between the fastening bolts in the center-connecting line.

Further, the reinforcing rib is provided at each of the middle sections between the adjacent fastening bolts in the direction connecting centers of the adjacent cylinders where the rigidity of the outer wall is the smallest so as to improve the rigidity and average out the deformation of the cylinder top plate.

Furthermore, the reinforcing rib is provided at each of the middle sections and the reinforcing rib has a semicircular cross-sectional shape in the same manner as bosses for the fastening bolts so as to improve the rigidity and simplify the molding thereof.

Moreover, the reinforcing rib connects to the vertical part of the crankcase at the connection section thereof arranged lower than a supporting boss of the crankcase for supporting the cylinder liner so as to suppress the falling-down deformation of the supporting boss toward inside of the cylinder when the cylinder liner is supported by the supporting boss.

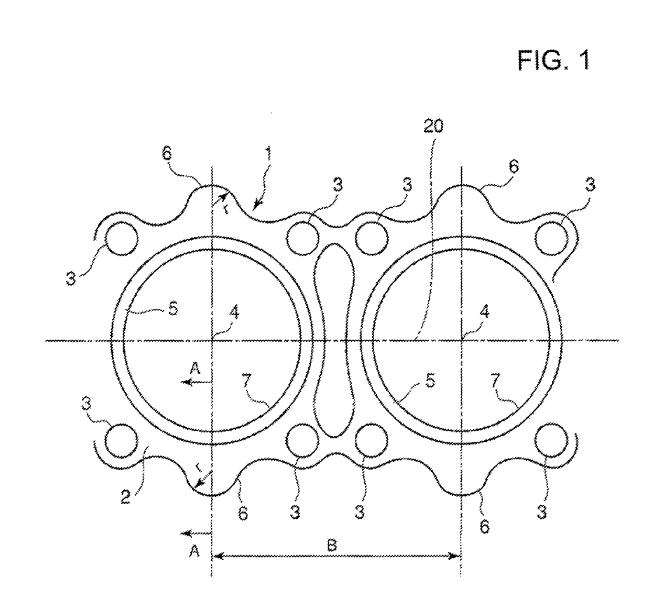

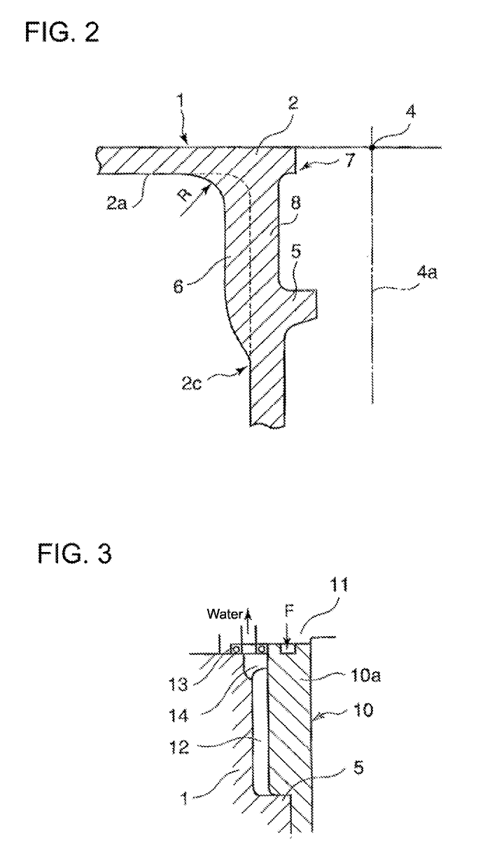

### BRIEF DESCRIPTION OF THE DRAWINGS

[FIG. 1] A plain view of main parts of a crankcase for a diesels engine relating to a preferred embodiment of the present invention.

[FIG. 2] A sectional view in relation to the preferred embodiment taken along a line A-A of FIG. 1

[FIG. 3] A sectional view of the crankcase having a cylinder liner installed therein in relation to the preferred embodiment of the present invention.

[FIG. 4] A plain view of main parts of a conventional crankcase corresponding to FIG. 1.

### DETAILED DESCRIPTION OF THE PREFERRED EMBODIMENTS

A preferred embodiment of the present invention will now be described in detail with reference to the accompanying drawings. It is intended, however, that unless particularly specified, dimensions, materials, shape, its relative positions and the like shall be interpreted as illustrative only and not limitative of the scope of the present.

FIG. 1 is a plain view of main parts of a crankcase for a diesels engine relating to a preferred embodiment of the present invention.

In FIG. 1, a crankcase 1 comprises two cylinders in line installed upright adjacent to each other. Further, a plurality of bolts for fastening each of the cylinders 7 to a cylinder head are provided on a cylinder wall arranged around each of the cylinders. Throughout the drawings, the fastening bolts are shown as fastening bolt holes 3. In FIG. 1, head bolt reinforcing members 3a are provided around the cylinder hole and each of the reinforcing members protrudes around the cylinder hole by 45 degree from each other from the horizontal and vertical lines and the fastening bolt holes are bored to meet the reinforcing members.

A center of each cylinder 7 is indicated by a numeral 4, and a distance between the centers 4 is indicated by B. Further, a line connecting the centers 4 of the adjacent two cylinders is indicated by a numeral 20 (center-connecting line 20, hereinafter).

The crankcase 1 has a cylinder top plate 2 formed on a top thereof. On the cylinder top plate 2, a pair of the fastening bolts 3 is provided on each side of the cylinder top plate 2 for each of the cylinders 7 with respect to the center-connecting line 20 connecting the centers of the cylinders. However, the number of the fastening bolts and the fastening bolt holes can be arbitrary.

As shown in FIG. 2, each of reinforcing ribs 6 is provided at a middle section between the pair of the fastening bolts (shown as bolt holes 3) of an outer wall of the cylinder (cylinder wall).

The reinforcing rib 6 extends continuously from a bottom surface 2a (ref. FIG. 2) of the cylinder top plate 2 (with a connection radius R) in a direction parallel to a center line of the cylinder and connects smoothly to a vertical part 8 of the crankcase 1 at a bottom portion thereof as shown in FIG. 2.

Further, FIG. 3 illustrates a sectional view of the crankcase 1 having a cylinder liner 10 installed therein. In FIG. 3, a shoulder part 10a of the cylinder liner 10 is pushed downward between the cylinder head 11 and a supporting boss 5 of the crankcase 1 by a force F, and a water chamber 12 is formed outside of the shoulder part 10a. The water chamber 12 is in communication with the cylinder head 11 at an exit 14 thereof. A plurality of O-rings 13 for sealing is also shown in the drawing.

In the present invention, the reinforcing rib 6 connects smoothly to the vertical part 8 of the crankcase at a connection section 2c thereof which is arranged lower than the supporting boss 5 of the crankcase for supporting the cylinder. The connection section 2c is supported by a high rigid portion of the supporting boss 5.

The connection section 2c is arranged lower than the supporting boss 5 so that the strength of the supporting boss 5 is reinforced by the reinforcing rib 6 in the vertical direction thereof and thus the falling down deformation of the supporting boss 5 to an inner side thereof when supporting the cylinder liner 10 is prevented.

In this manner, in the preferred embodiment, the reinforcing rib 6 is provided at each of the middle sections between the bolt holes 3 on the outer wall of the cylinder, where the rigidity is the smallest.

By providing the reinforcing rib 6 at the middle section where the rigidity of the outer wall is the smallest, the rigidity of the part is improved and the deformation of the cylinder top plate is averaged out.

Moreover, the reinforcing rib 6 has a semicircular cross-sectional shape with radius r in the same manner as the boss for the fastening bolts 3 so as to enhance the strength thereof.

As described above, the deformation of the cylinder top plate 2 is substantially high at the middle section which has only few bosses in the area and in the present embodiment, the reinforcing rib is formed on the outer wall of the cylinder at the middle section in the direction connecting centers of the adjacent cylinders and the reinforcing rib 6 extends downward continuously from the bottom surface 2a of the cylinder top plate 2 in a direction parallel to the center line 4a of the cylinder so as to improve the rigidity at the middle section and further prevents the droop of the top plate 2 toward inside of the cylinder 7, thereby preventing the deformation of the cylinder top plate.

Accordingly, the deformation of the cylinder top plate 2 can be suppressed by simply adding the reinforcing rib 6 which is a inexpensive and simple means with a simple structure requiring a few extra processes. This can obtain a crankcase 1 capable of coping with increased combustion pressure inside a cylinder due to a high supercharging and a high output of an engine.

### INDUSTRIAL APPLICABILITY

According to the present invention, a structure of a crankcase capable of coping with increased combustion pressure inside a cylinder due to a high supercharging and a high output of an engine can be obtained by using a means which can suppress the deformation at the middle section between the fastening bolts in the center-connecting line with a simple inexpensive means of a simple structure requiring only few extra processes.

1. A structure of a crankcase which has a plurality of cylinders and a plurality of bolts arranged on both sides of each of the cylinders for fastening the cylinders to a cylinder head, the structure of the crankcase comprising:
a reinforcing rib formed on an outer wall of the cylinder at a middle section between the adjacent fastening bolts in a direction connecting centers of the adjacent cylinders, the reinforcing rib extending downward continuously from the cylinder top plate in a direction parallel to a center line of the cylinder.

2. The structure of the crankcase according to claim 1,
wherein the reinforcing rib is provided at each of the middle sections.

3. The structure of the crankcase according to claim 2,
wherein the reinforcing rib has a semicircular cross-sectional shape in the same manner as bosses for the fastening bolts.

4. The structure of the crankcase according to claim 1,
wherein the reinforcing rib connects to a vertical part of the crankcase at a connection section thereof which is arranged lower than a supporting boss of the crankcase for supporting a cylinder liner.

5. The structure of the crankcase according to claim 1, which has a plurality of in-line cylinders installed upright in vicinity of each other, and a plurality of bolts arranged on an outer wall surrounding each of the cylinders for fastening the cylinders to a cylinder head, the structure comprising:
the reinforcing rib formed on the outer wall at a middle section between the adjacent fastening bolts in a direction parallel to a direction of a center-connecting line connecting centers of the adjacent cylinders, the reinforcing rib extending downward continuously from the cylinder in the direction parallel to the center line of the cylinder.

6. The structure of the crankcase according to claim 5,
wherein the reinforcing rib is provided at each of the middle sections.

7. The structure of the crankcase according to claim 5,
wherein the reinforcing rib is provided at each of the middle sections and the reinforcing rib has a semicircular cross-sectional shape in the same manner as bosses for the fastening bolts.
